(19) United States
(12) Patent Application Publication
(10) Pub. No.: US 2009/0124159 A1
(43) Pub. Date: May 14, 2009

(54) Method of fabrication of cold cathodes on thin diamondlike carbon films irradiated with multicharged ions and field emissive corresponding surfaces

(76) Inventor: Jean Pierre Briand, Antony (FR)

Correspondence Address: ZIMMERMAN & CRONEN, LLP, 1330 BROADWAY, SUITE 710, OAKLAND, CA, 94612-2506, US

(21) Appl. No.: 12/070,615

(22) Filed: Feb. 19, 2008

(30) Foreign Application Priority Data
Mar. 2, 2007 (FR) 05 0833

(51) Int. Cl. H01J 9/02

(52) U.S. Cl. 445/49

(57) ABSTRACT

The invention relates to a method of fabrication of cold cathodes by irradiation of doped Diamond Like Carbon (DLC) films with multicharged ions. According to the invention each multicharged ion prints on the surface an isolative dot from which, directly or after a conditioning process, one can extract at room temperature intense electronic currents with very low electric fields. These dots may be printed on very inexpensive DLC films on areas, of predetermined shapes, sizes and emissivity. The invention also relates to the corresponding emissive surfaces and all applications of the method to the fabrication of electron guns of exceptional intensity and geometrical properties and owning very low energy consumption to be used for portable instruments. These cold cathodes may be used in all instruments based on electron beams, such as flat panel displays, x ray or all electronic tubes, vacuum components and so on.

A method of fabrication of cold cathodes on thin Diamondlike Carbon films irradiated with multicharged ions and field emissive corresponding surfaces.

The present application is the subject of a French application for a patent No 05 0833 made by me and published in the Bulletin Officiel de la Propriété Industrielle No 09 on Mar. 2, 2007 N° 2 890 231

The invention relates to a method of printing on the surface of a doped Diamond Like Carbon (DLC) film of isolative nanometric dots owning field emission properties wherein:
a thin isolative DLC film is doped enough to acquire electrical conductivity
a beam of positive multicharged ions of charge larger than 2 is send towards the surface of the doped said DLC films.

The invention also relates to a corresponding DLC surface on which such field emissive dots have been printed.

The invention also relates to the application of this method to the fabrication of cold cathodes to be used in all instruments or devices using electron beams.

Electron beams are used in many different applications such as cathodic screens, flat panel displays, Rf tubes, x ray tubes . . . . Electron guns allowing preparing such beams are made of a source of electrons and an electrostatic focusing device providing an electric field allowing to extract and focus the electron of the said source.

The electron beams extracted from the surfaces of a given material exposed to an electric field depends on the work function of the considered material, its temperature, and of the value of the applied electric field at the said surface. To extract intense electronic currents from most materials at room temperature one must apply huge electric field of the order of 10¹⁰ V m⁻¹, difficult to produce at low cost. Commercial electron guns most currently sold are made of hot cathodes heated at temperatures of the order of one thousand degrees, allowing obtaining high current densities when exposed to electric fields of the order of 10³ up to 10⁴ V m⁻¹. Such electron guns request a lot of energy to heat directly or indirectly the said cathodes providing heat that have to be evacuated and cannot be easily used on embarked or portable devices.

The extraction of intense electron beams at room temperature, in the so called cold cathodes, may however be performed at voltages low enough to be compatible with commercial requirements either, for a given bias, by increasing locally on the surface of the cathode the electric field on sharp tips allowing to extract electrons from conventional materials owing a quite high work function (4-6 eV), or by using materials owning a low work function such as for instance diamond films whose surfaces are passivated by an atomic hydrogen layer (or in a more general way carbon based surfaces), as described by F. J. Himpsel et al. in Phys. Rev. B20 (1979) 624 and J. Robertson in Material Science and Technology R27 (2002)127.

The technique based on the local geometrical increase of the electric field, the most studied in years 1995-2000 in view of its use for the fabrication of cold cathodes owning low energy consumption, was based on the building of microscopic pyramids as described by C. A. Spindt, et al. in J. Appl. Phys. 39(19686)3504, the summit of which being a sharp tip able to constitute a micro emitter of electrons allowing for instance to properly excite one pixel on a flat panel display. Such technique is now abandoned owing to its high cost.

In the last few years a new technique using the enhancement of local electric fields on sharp tip, based on the use of Carbon NanoTubes (CNT) opened the way to an alternative method to manufacture cold cathodes and led to many researches and huge investments. The principle of the method is to grow, normal to a surface a high density of CNT used as nanometric tips allowing to extract by field effect intense electronic currents with electric fields as low as few Vμm⁻¹. Small electron guns delivering electron beams of few mA with few hundred volts, based on these techniques are already available on the market.

Before and in parallel, an alternative technique using the very low work function of diamond based flat surfaces was developed. The first motivation of the researches was based on an original property of crystalline diamond passivated by an atomic monolayer of hydrogen which owns a negative electron affinity, and then a low work function. It was then very soon recognized that it was possible to extract at room temperature electron beams of sufficient intensity to properly illuminate the pixels of a flat panel display with electric fields of the order of few volts per μm i.e. the typical distances between a cathode and a pixel in a flat panel display. Most experiments in the field have been carried out with diamond films prepared using the CVD (Chemical Vapour deposition) technique which allows preparing diamond films of micrometer sizes but made of a mosaic of micrometric crystalline diamonds. One of the major results obtained in the last decennia in the study of the emissive properties of polycrystalline diamond has been to discover that the electron emissive areas were actually located on the borders of the graphitic joints linking the micro crystals. This technique has now been abandoned owing to its large cost.

The researches then move to the study of the emissive properties of Diamond Like Carbon (DLC), sometimes designated as tetrahedral diamond or (a-t C). DLC is an allotropic variety of carbon which does not own the fcc crystalline structure of gem diamond but whose chemical bounds are nevertheless mainly of the sp3 type, and which owns a resistivity, mechanical properties, and a chemical inertness comparable to that of diamonds and may be manufactured at a much mower cost. It has then been discovered that the DLC films own emissive properties comparable to those of H covered diamonds. Later on it has been discovered that these emissive properties were not mainly due the negative electron affinity of the surface but rather to the formation of local structural changes of variable micrometric size, induced by micro discharges created when the DLC film is first exposed to an electric field, the so called conditioning process. It has also been discovered that the electron emission comes from the borders of these local defects as described by J. B. Cui in Applied Phys. 89 (2001) 3490, in a way similar to what was found for micro diamonds. The number of such emissive printed areas has been found however not to exceed few 10⁶ cm⁻² which limits the overall available extractable intensity and was not very reproducible.

According to the invention it is possible by irradiation under vacuum of thin doped DLC films with multicharged positive ions of charge higher than 2, to create on the surface of these DLC films, in a very reproducible way, a predetermined number, equal to the number of ions impacting the surface, of similar emissive nanometric site defects the size of which being lower than 100 nm, named ‘dots’ in the followings, of predetermined identical shapes and sizes depending of the charge, energy and incidence angle toward the surface of the multicharged ions. These dots own surprisingly the property of being able to emit intense electron current densities at room temperature, when exposed to electric fields of the order of few V μm⁻¹ up to few 100 V μm⁻¹ allowing, while printed in a sufficient number, to manufacture macroscopic surfaces of cold cathodes providing up to hundreds of mA cm⁻², directly or after a conditioning treatment.

This level of performances will be in the following named ‘required performances’. This technique allows then, just by irradiating a doped DLC film with multicharged ions to print on inexpensive films a predetermined number of dots, of predetermined size and emissivity, and to create macroscopic emissive areas of predetermined emissivity, shape and size.

According to the invention this technique may challenge the technique based on the grow of CNT which needs a complex series of manipulations, not easily reproducible, or may not own a long durability, compared to the DLC surfaces which are extremely stable, and hard enough to survive long term electron emissions.

Beyond the total intensity extracted from a cathode of an electron gun, the kinematics and the geometrical properties of the beam delivered by an electron gun are extremely important parameters conditioning all various uses of such beams. The energy acquired by the extracted electrons, as well as the focusing properties of the extracted electron beams in e.g. Wehnelt electrodes, are defined by the shape and the size of the emitting zone of the cathode. According to the invention it is possible by printing a predetermined number of dots, of predetermined emissivity, on areas of predetermined shape and size, to accurately control and improve the properties of the electron guns. This advantage is of prime importance for obtaining for instance high resolution images with e.g. x ray tubes for which the smallness of the emissive cathode defines all optical properties.

The surface modifications induced by multicharged ions on dielectric surfaces are essentially due to the original general properties of the interaction of these ions with surfaces. By contrast to what happens with singly charged ions the large electric charge carried by these ions allows the interaction with the surface to hold before any contact with the surface (the so called potential interaction). These multicharged ions create at very close distances from the surfaces (z₀) of the order of a nm, very large electric-fields of the order of 10⁹ up to 10¹¹ Vm⁻¹ allowing to locally extract and capture by field effect, on a surface of few nm², a very large number of electrons. Above metal surfaces the extracted electrons are quasi instantaneously replaced. Above dielectric surfaces the positives charges created by the exodus of the electrons cannot be neutralized in a time shorter than that of the interaction of the ion with the surface. The intense repulsive forces between these adjacent positive charges may lead to what was first called a Coulomb explosion as described by I. S. Bitenski et al. in Solids 24 (1979) 618.

These intense forces may induce irreversible structural changes on the surface. The ions may simply sputter the surface, removing superficial atoms, and/or create craters, peaks or blisters as described by D. Schneider et al. in Radiation Effects and Defects in Solids 127 (1993) 113. Each ion may, at distance, before any contact, change the structure of the surface on a very small area in very different ways. The ions may locally amorphize a crystalline structure, but also create on amorphous surfaces nanocrystals. These modifications only depend on the charge, energy and incidence angle of the ion, and of the nature of the surface. On crystalline diamonds these multicharged ions create conductive dots resulting from the break of the diamond fcc crystalline structure into a graphitic phase as described by J. P. Briand et al. in U.S. Pat. No. 6,402,882 B1, and on Highly Orientated Pyrolytic Graphite (HOPG) surfaces, nanodiamond as described by T. Meguro et al. in Appl. Phys. Lett. 79 (2002) 3866. The size of these dots only depends on the charge, energy and incidence of the considered multicharged ions, as well as of the work function of the considered material which define the maximal distance of interaction z₀ at which the multicharged ions start extracting electrons from the surface. After interacting above the surface (potential interaction) and creating local structure modifications, these multicharged ions may, or may not, depending on their energies, touch the surface where they may induce, or not, additional surface modifications (kinetic interaction).

These dots printed on various surfaces may be used for industrial applications either for their topographic properties (peaks, craters or blisters), or their electrical properties as described by J. P. Briand in U.S. Pat. No. 6,355,574 B1 and U.S. Pat. No. 6,841,249 B2. U.S. Pat. No. 6,355,574 B1 describes a process based on the irradiation with multicharged ions of hydrogen passivated silicon surfaces, which are known to be conductive, allowing printing isolative nanometric dots on such conductive surfaces. According to this technique the irradiation of the said surfaces by multicharged ions locally sputters on a nanometric dot the H layer, which correlatively makes chemically active the dangling bounds of the silicon atoms located on this dot, which after being exposed to oxygen may be oxidized then forming silicon dioxide isolative dots on a conductive surface. In U.S. Pat. No. 6,841,249 B2 it is shown that these ions print on insulating diamond surfaces conductive nanometric dots.

In U.S. Pat. No. 6,402,882 B1 J. P. Briand describes a technique allowing to precisely control the position of each of these dots on the surface.

According to the present invention the irradiation with multicharged ions of conductive doped DLC films deposited on a conductive substrate leads, surprisingly, to the formation on the surface of these films, of specific dots which exhibit, directly or after a conditioning process, or irradiation with electrons or photons, very remarkable properties of electronic emission by field effect, at room temperature, when exposed to an electric field, allowing to manufacture efficient cold cathodes.

The process according to the present invention differs from the process described in U.S. Pat. No. 6,841,249 B2 by the fact that, according to this said patent, the irradiation with multicharged ions of insulating diamond surfaces creates conductive dots on an insulating material, electrically isolated each others and with respect to the substrate, forming electron reservoirs allowing to store a small number of electrons, while in the present invention one creates on doped, and then conductive, DLC films insulating dots. One of the quoted uses of such said electron reservoirs described in U.S. Pat. No. 6,841,249 B2 was to serve as replenishment reservoirs for cold cathodes, while the present invention deals with the creation of different kinds of dots, owning emissive properties, and feed by the electrons coming from the conductive doped DLC film, in which it is not possible to create isolated conductive reservoirs. Such electron reservoirs, which actually would not allow obtaining DC currents, as they may have to be refilled after being emptied, cannot then be used in the process according to the present invention.

The dots according to the invention can be used either as individual electron emitter sites or grouped in a given area of the surface to form a macroscopic cold cathode adding the emissivity of the individual dots. The multicharged ion beam may be directed to the doped DLC films through holes of predetermined sizes and shapes allowing to only irradiating a given predetermined area of the surface. Alternatively one can irradiate a given predetermined area of the surface of the doped DLC film by sweeping the ion beam, using conventional deflection techniques, to print a cold cathode following a predetermined pattern. After being irradiated the doped DLC films may be cut, if needed, according to the actual printed pattern. These cold cathodes to be used to manufacture electron guns, must then be located in a set up in which an electric field of suitable structure is applied allowing extracting the electrons. These cold cathodes may be set in front of a biased mesh allowing to extract and control the intensity of the electron beam, and/or inside an electrode e.g. of the Wehnelt type, to focus the extracted electron beam, and to direct it towards the device in which the beam will be used.

The multicharged ions are always extracted from the ion sources with a certain amount of kinetic energy of the order of few keV/q up to few tens keV/q allowing their extraction from the plasma or the electron beam where they are prepared. These ions have to be decelerated to a much lower energy, of the order of few eV/q up to hundreds of eV/q or very few keV/q, and directed to the surface at an incidence angle close to that of the normal to the surface. At the lowest energies the multicharged ions may be backscattered above dielectrics by the Trampoline effect and only interact at distance from the surface (potential interaction). At higher energies the multicharged ions touch and penetrate the surface. According to the invention the given kinetic energy of the ions, as well as their charge and incidence, allow the control of the structural changes induced by the multicharged ions such as the size of the dots, the nature of their borders with the rest of the surface, and their emissivity.

The number of dots printed on a given area of a predetermined shape and size on the surface of the doped DLC film to manufacture a given macroscopic cold cathode is limited by the size of these dots compared to the whole surface where they have to be printed which, while erratically printed, must not touch each others, and one must not print more than 10¹² dots cm⁻² to avoid any percolation or recovering effect. In order to also avoid any static charging effects during the irradiation of the doped DLC films which may change the nature of the interaction of the ion with the surface of the film, owing to the limited neutralization time on the surface of a printed dot, one must not irradiate the doped DLC films with ionic current densities larger than few hundred nA cm⁻².

There are many available techniques of preparation of DLC films. These techniques are all based on the deposition of carbon atoms extracted from beams or plasmas such as, in a non exhaustive way: FCVA (Filtered Cathodic Vacuum Arc), PCVD (Chemical Vapor Deposition), NIBD (Negative Ion beam Deposition). DLC then exists on slightly different forms and structures depending on the technique of preparation. These slightly different DLC films are characterized, in a non exhaustive way, by their sp2/sp3 ratios, their contents in hydrogen, the rugosity of their surface, and the quality of their surfaces. The size, structure and emissivity of the emissive dots depend on the actual nature of the DLC films prepared using these various techniques. These parameters play a role as well on the formation of the dots and on their emissivity, as on the maximum extractable electronic current from the built cold cathodes, which depends on the ability to feed the dots in electrons then of the conductivity of the DLC films which is mainly defined by their thicknesses and levels of doping, and by the nature of their contact with the substrate on which they have been grown. The actual properties of the dots prepared according to the invention then depend on the way these DLC films are prepared and which, even when prepared by the same technique of fabrication, may be different from a set to an other. According to the invention it is then necessary to optimize the parameters of irradiation of the DLC films by the multicharged ions and the further treatments to activate or improve the emissivity, such as conditioning processing or an irradiation with an electron or photon beam, to fit with the requested characteristics of the cold cathodes under fabrication. The irradiation set up must then comprise for on line adjustments all instruments needed to improve, activate, control and measure the overall emissivity of the cold cathode. A first try of irradiation with multicharged ions on a small test part of each of the doped DLC films may then be performed, followed by emissivity measurements before the final irradiation of the whole doped DLC film.

The multicharged ions are advantageously produced by the ECRIS (Electron Cyclotron Resonance Ion Sources) or EBIS (Electron Beam Ion Sources). The multicharged ions are extracted either from a plasma (ECRIS) or an electron beam (EBIS) by e.g. positively biasing the vacuum vessel were the ions are confined and ionized at a potential Vs. The ions then have at the exit of the sources a kinetic energy (Vₛ+Vₚ)q e, Vₚ being the potential plasma of the ECRIS source or the charge space in the electron beam for the EBIS sources, e the electron charge and q the number of charges of the multicharged ion. The kinetic energies of the ions delivered by these ion sources are typically of the order of few keV/q up to few ten keV/q. The slowing down of these ions may be advantageously performed with two different techniques said high field and low field.

In the high field technique one bias the target to be irradiated to a positive potential between 0 and Vₛ+Vₚ, the beamline and the vacuum vessel of the irradiation device being grounded. The ion beam entering along the axis of the vacuum vessel of the irradiation device passes through a metallic device of appropriate shape as described in the book Accelerator Based Atomic Physics Techniques and Applications, S. M. Shaffroth and J. C. Austin, Ed. AlP press, p 349, biased at a negative potential in which the ion beam is focused and then decelerated by biasing the target at a potential Vₛ+Vₚ in order to give the ions a kinetic energy comprised between the energy at which they have been extracted from the sources and zero. This technique allows a good compromise between the angle of incidence of the ions on to the surface which must be close to the normal at the surface and the inherent defocusing properties of decelerated beams. In the considered case the electric field close to the surface is of the order of 10⁶ Vm⁻¹.

In the low field technique the ions are decelerated in a more conventional way before entering the irradiation device through a series of lenses allowing the target to be grounded which makes easier the positioning of masks or holes in front of the target, or the sweeping the ion beam. In that case the electric field in front of the target is close to zero.

These two techniques lead to slightly different properties of the printed dots. The invention will be illustrated and better understood using embodiments and modes of realisation of the invention specified below, with references to the appended drawings, wherein:

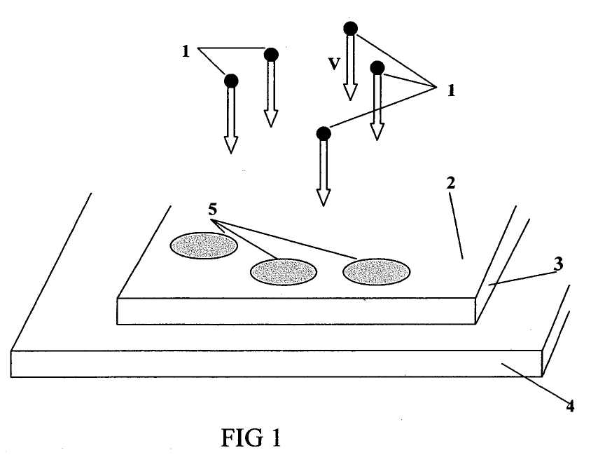

FIG. 1 shows the arrival of a plurality of multicharged positive ions 1 (black points) of velocity V on the surface 2 of a doped DLC film 3 grown on a conductive substrate 4, and structurally modified dots 5 (grey circles) previously printed by the ions 1 on the surface 2 of the doped DLC films 3.

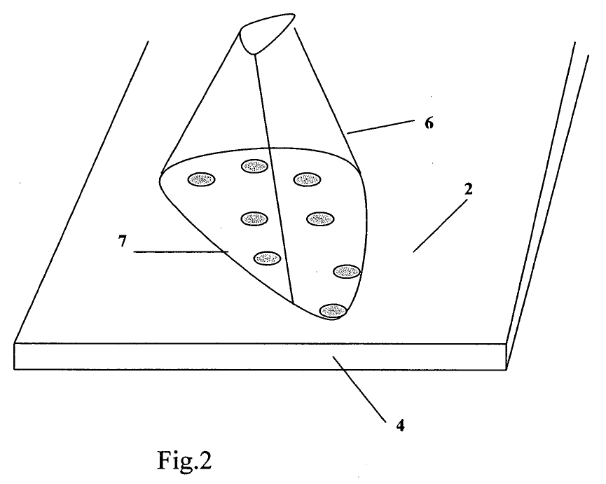

FIG. 2 shows the envelop 6 of the beam of multicharged ions 1 impinging the surface 2 of the doped DLC film 3, and the contour 7 of the macroscopic part of the surface where the beam has printed a plurality of dots 5 to form a macroscopic cold cathode.

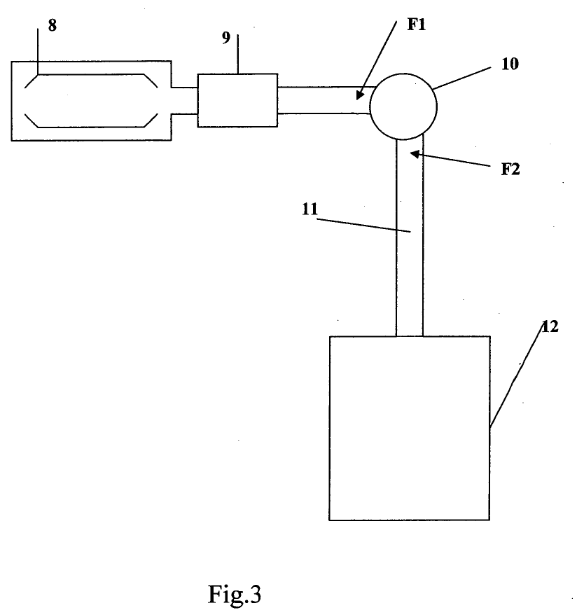

FIG. 3 shows the beamline used in all preferred embodiments, conducting the multicharged ions 1 inside the area of contour 7 of the surface 2 of the doped DLC film 3 to be irradiated, which is made of an ion source 8, a magnetic or electric lens or a solenoid 9 allowing to focus the beam at a point F1, a bending magnet 10 to select the mass and the charge of the multicharged ions under consideration and to focus it at point F2, the vacuum pipe 11 allowing to direct the beam to the irradiation device 12.

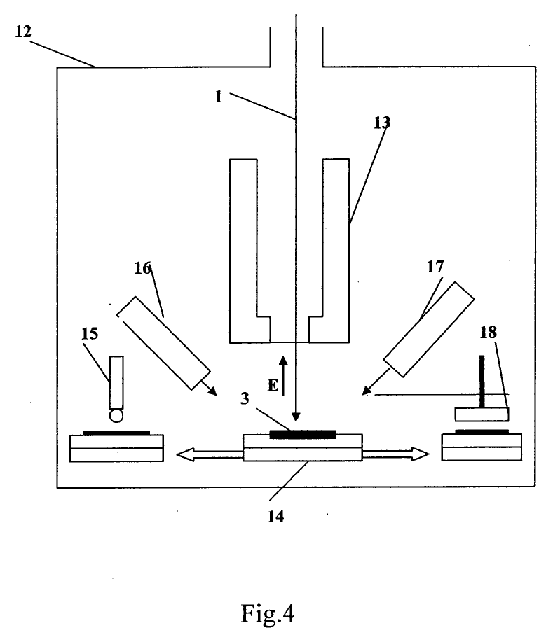

FIG. 4 shows the irradiation device using the strong decel process. This set up under vacuum comprises a device 13 to focus the considered multicharged ion beam described in the book Accelerator Based Atomic Physics Techniques and Applications, S. M. Shaffroth and J. C. Austin, Ed. AlP press, p 349. The DLC film to be irradiated is deposed a insulated translator 14 based on a precision piezoelectric crystal or a ceramics allowing to move the doped DLC film 3 below the beam of multicharged ions or towards the instruments of control or activation 15, 16, 17, 18. 15 is an emittometer allowing to measure locally the emissivity of a small test zone. 16 and 17 are commercial sources of electrons or photons allowing activating or improving the emissivity of the surface after irradiation with multicharged ions. 18 is a biased metallic plane under which one may locate the irradiated doped DLC films to measure the whole emissivity of a macroscopic emissive area.

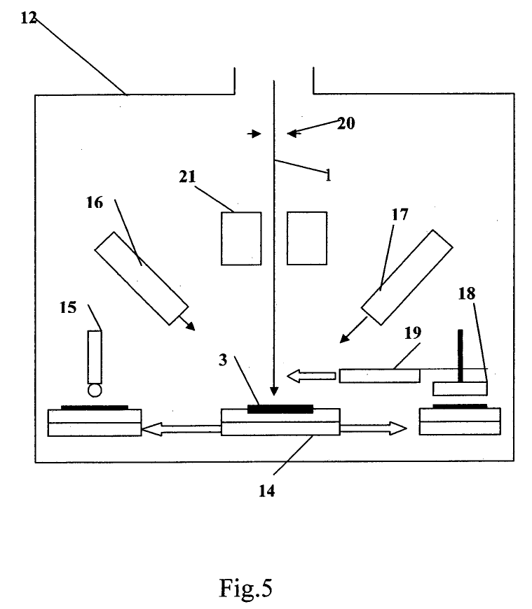

FIG. 5 shows the irradiation set up using the low field decelerating technique. This set up under vacuum is made of the same instruments 15, 16, 17, 18 than in FIG. 4. It comprises additionally a removable mask 19, a slit 20 allowing limiting the beam upstream and a sweeping device 21. This set up is isolated with respect to the ground in order to be biased.

As the DLC films 3 to be irradiated according to the invention are not always exactly identical, each run of irradiation must be preceded by adjustments of the multicharged ion irradiation parameters, and the further possible activation or improvement processes, to the genuine characteristics of the available film to fit with the required specifications of the desired cold cathode. One may then first irradiate with multicharged ions, and possibly immediately improve and or activate by irradiation with electron or photon beams or by inducing micro discharges, a very small part of the DLC film, said test zone, and checks the emissivity of the said test zone using the emittometer 15 before processing the whole film. These activation and/or improvement processes can be performed by irradiating the doped DLC films, already irradiated with multicharged ions, with an electron beam delivered by an electron source 16 and or a beam of photons delivered by a photons source 17. One may also advantageously expose the said surfaces already irradiated with multicharged ions, to a relatively high electric field in device 18 to create micro discharges on the dots 5 which then serve as germs to be activated.

The emittometer 15 is a well known kind of device made of a metal rod perpendicular to the surface, at the end of which is attached a conductive half ball with a radius of curvature smaller than few mm, and which can precisely move close to the emissive surface to be characterized. The tip is biased at a given voltage and set at a given distance of the surface to generate a given electric field, and one measures the extracted current from the said surface versus the applied electric field. The measurement may be performed either by varying the bias applied to the tip or by changing the distance from the tip to the said surface. Alternatively the emissivity of the whole treated surface can be measured by setting in front of the surface to be characterized a biased metallic plane 18 parallel to the surface, and measuring the extracted intensity versus the applied voltage.

The procedure according to a common embodiment can be described as illustrated in FIG. 3, 4 and 5 by completing the following operations:

one grows, using any of the presently available techniques of preparation, a DLC film onto a very flat conductive support 4, advantageously made of a clean doped silicon wafer whose rugosity is of the order of 0.5 nm;

one dopes the DLC film either during its preparation or after its preparation with suitable atoms, advantageously molybdenum, at a dose suitable to reach the required conductivity for a required overall emissivity of a given electron gun;

one introduces under clean vacuum the doped DLC film 3 into the irradiation set up 12 and clamps it on the manipulator 14;

one prepares multicharged ions in an ion source advantageously of the ECRIS (Electron Cyclotron Resonance Ion Source) or EBIS (Electron Beam Ions Source) type or any other device delivering such ions;

one extracts the multicharged ions produced by the said source into a series of pipes under a very clean vacuum, exempt of hydrocarbon, advantageously at a pressure lower than 10⁻⁷ mb, and one sends the said multicharged ion beam into a focusing set up 9 made of an electrostatic or magnetic lens or a solenoid, allowing to focus the said beam at point F1 in FIG. 3;

one selects the desired ion of charge q and mass m in a magnetic dipole, advantageously focusing the beam at point F2 in FIG. 3;

one directs the beam under vacuum with magnetic or electrostatic lenses into the irradiation vacuum vessel 12 as shown in FIG. 3.

In a first preferred embodiment as shown in FIG. 3 and FIG. 4:

one carries out all operations of the common mode of operation and specifically:

a) one bias the vacuum vessel of the ion source at potential Vₛ;

b) one sends the ions through a nose to the grounded beamline and directs them inside the irradiation device 12 at ground voltage;

c) one focuses the ions 1 in the specially designed lens 13 onto the surface 2 of the doped DLC film 3 to be irradiated biased at a voltage comprised between Vs+V_{P} and the ground, in order to give the multicharged ions a given kinetic energy between zero and eVₛ/q+V_{P}/q preferably at energies known as thermal or suprathermal energies lower than 10 keV/q, preferably at an incidence angle to the normal to the surface lower than 30 d°;

d) one irradiates the surface 2 of the doped DLC film 3 with a given dose of the said multicharged ions 1, such a process leading, according to the invention, to the formation of a plurality of emitting sites 5;

e) one moves the DLC film parallel to it with the translator 14 in front of the tip of the emittometer 15 to measure the extracted currents on a test zone of the surface, or to the biased metallic plane 18 to measure the whole emissivity of the whole irradiated surface;

f) if the measured emissivity does not fit with the given requirements for a given electron gun, one may re irradiates the surface with an increased multicharged ion dose, at another energy or with another ion of different charge and mass, and or one irradiates the doped DLC film with the electron beams provided by the electrons or photons delivered by devices 16 or 17, or one sets the said DLC film in front of the biased plane in device 18 to create micro discharges, until one reaches the desired performances.

In a second preferred embodiment one decelerates the ions 1 to the desired energy between the multicharged ion source 8 and the irradiation vessel 12 and one specifically carries out the following operations:

1) one extracts the multicharged ions 1 from the ion source 8 which one decelerates at an energies known as thermal or suprathermal energies lower than 10 keV/q using well known techniques with electrostatic lenses, and directs it into the irradiation device 12 of FIG. 5;

2) one directs the beam of the multicharged ion 1 on the surface 2 of the doped DLC film 3 preferably at an incidence angle to the normal to the surface lower than 30 d° through the mask 19 or the slit 20 allowing to only irradiate a predetermined area of the surface or through the sweeping device 21, or through the slit 20 below which one moves the said DLC film;

3) one repeats all operations d) to f) of the previous procedure.

One then removes the so treated doped DLC films according to the first or second preferred mode of operation, and if necessary cut it to give it the required size and one sets it below a mesh or inside an electrode of e.g. the Wehnelt type of adequate shape allowing to extract, focus and direct the electron beam to manufacture an electron gun.

The impact with or without contact of a multicharged ions 1 generates the emission of a certain number of electron, photons or sputtered atoms which may be advantageously used to control the position and the emissivity of a given macroscopic zone on which one has printed a certain number of emissive sites. One then directs through a hole located above the surface to be irradiated an predetermined number higher than one, of multicharged ions one carries out the following operations:

one identifies the impact of the plurality of multicharged ions having printed a first zone located below the hole by detecting electrons, photons or ions emitted during the said impact, altogether or separately, this detection allowing to create an electrical signal allowing to shut down the beam during a predetermined time by applying an electric field shifting the multicharged ion beam outside the said hole;

one moves the surface to be treated which is mounted on piezoelectric quartz or a ceramic by a predetermined amount within a fraction of nm precision;

one re opens the multicharged ion beam in order to print a new area;

and one repeats these operations to print on the surface a predetermined number of these areas with a predetermined dose in order to draw a predetermined pattern.

In U.S. Pat. No. 6,402,882 B1 is described a similar technique of printing. In this technique after having printed a single dot with a single ion one collect the electron, photons and ion emission to form an electric signal shutting down the ion beam during a predetermined time. The technique only applies if one can collect enough emission from a single ion which is very rare owing to the limited available solid angles for this detection. If no signal is formed another ion may be printed at the same place than the first one and so on. One cannot then be sure of having just one dot printed in the considered area. The technique used in the present invention differs then from that described in U.S. Pat. No. 6,402,882 B1 in that instead of printing dots after dots one prints groups of dots by group of dots.

In another preferred embodiment on uses intrinsic DLC for preparing special cold cathodes owning very specific characteristics.

The emissive surfaces prepared according to the invention may be used in all industrial applications requesting an electron beam and advantageously the applications requesting portable or embarked devices requesting low energy consumption and not allowing an easy evacuation of the heat dissipated by hot cathodes such as filaments.

These cold cathodes in a general way may be used in all applications of imagery using electron beams such as oscilloscopes, flat panel displays etc. . . . In the case of flat panel displays one may manufacture individual emitting sources of electrons of extremely small dimensions down to nm sizes and or containing down to a single dot 5 to excite a single pixel of comparable dimensions, allowing to increase the resolution of the images. The resolution being much better than that usually required for a direct observation by the eye, one may advantageously increase the size of the image displayed on the screen on which they are formed with an optical magnifier.

These cold cathodes may also be used to manufacture portable x ray tubes or any other devices emitting light of any wavelength, to be for instance introduced inside a solid material or inside human or animal bodies for micro radiography, fluorescence analysis, and illumination and also to destroy living tissues or tumours.

These cold cathodes may also be used to replace the hot cathodes in any electronic tubes such as triodes, pentodes, in any application in circuitry active or passive, Rf tubes for the generation of microwaves for fix or embarked radars, all instruments used in vacuum technology such as vacuum gauges ionic pumps, mass spectrographs, leak detectors, gas analysis) or electron microscopy.

These cold cathodes may also be used in microlithography by electronic bombardment by using each site or irradiated area as geometrical model of surface modification.

1. A method of engraving isolative and field emitter nanometric dots on the surface of films of doped diamond Like Carbon (DLC) to build cold cathodes made of a plurality of said dots,
comprising doping a film of DLC in order to provide an electrical conductivity to said film
and directing a beam of multicharged positive ions of charge larger than 2 on said doped DLC film in order that each ion prints on the surface of the said doped film one of the said nanometric dots.

2. A film of Diamond Like Carbon (DLC) modified by the method according to claim 1 on which are engraved in predetermined zones a predetermined number of dots.

3. The method according to claim 1 to the fabrication of cold cathodes characterized in that a predetermined number of the said dots are engraved in predetermined zones inside the contour of the surface located of the said doped DLC films by sending exclusively the said multicharged positive ions onto the said predetermined zones enabling to manufacture cold cathodes of predetermined size, shape and emissivity to be a part in all instruments using electron beams.
